(19) United States
(12) Patent Application Publication
(10) Pub. No.: US 2018/0293559 A1
(43) Pub. Date: Oct. 11, 2018

(54) PROCESSING DATA SERVICE

(71) Applicant: ALIBABA GROUP HOLDING LIMITED, Grand Cayman (KY)

(72) Inventor: Dasong JI, Hangzhou (CN)

(21) Appl. No.: 15/526,312

(22) PCT Filed: Dec. 15, 2015
(86) PCT No.: PCT/US2015/065860

§ 371 Date: May 11, 2017

(30) Foreign Application Priority Data
Dec. 18, 2014 (CN) 201410800424.6

(51) Int. Cl. G06Q 20/10

(52) U.S. Cl. CPC G06Q 20/10

(57) ABSTRACT

An example method for processing data service includes the following operations: acquiring a data service request initiated by a first user to a second user, the data service request carrying a service limit of the data service; acquiring a data source list adopted by the second user in accordance with the data service request; and transferring an amount of funds for the service limit to a first account corresponding to the first user in accordance with the data source list. The technical solution of the present disclosure transfers a service limit to the first account corresponding to the first user in accordance with the data source list, which avoids an interruption of the data service caused by an insufficient single data source, and thus facilitates the data service, and enhances a quality of service of the data service.

### CROSS REFERENCE TO RELATED PATENT APPLICATION

This application claims foreign priority to Chinese Patent Application No. 201410800424.6 filed on 18 Dec. 2014, entitled “Method and Apparatus for Processing Data Service,” which is hereby incorporated by reference in its entirety.

### TECHNICAL FIELD

The present disclosure relates to the field of Internet technology, and more particularly to a method and apparatus for processing data service.

### BACKGROUND

With the increasing prevalence of online shopping, buyers and sellers exchange goods and money over a network platform provided by an Internet operator. After receiving the goods, if the buyer finds any problems with the goods, the buyer often asks the seller for a refund. In a network secured transaction, if the money has not yet been paid to the seller, the money in the secured account of the seller is refunded to the buyer. Furthermore, if the money has already been paid to the seller and the buyer asks for a refund, there needs to be a guarantee mechanism that there is sufficient money in the account of the seller to refund to the buyer.

In conventional techniques, the seller is asked to deposit a certain amount of money, which is exclusively used for a refund to the buyer, that is, a deposit. In order to guarantee a successful refund to the buyer, it must be ensured that the seller has a sufficiently large deposit. Since the deposit still belongs to the seller's fund essentially, it is difficult to maintain sufficient funds all the time. Furthermore, the deposit occupies seller's funds, and returning such a deposit to the buyer as a refund would affect the fund liquidity of the seller. Since there is only one single source for the refund to the buyer in the conventional techniques, there is no exchangeability between different fund sources.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

In view of the above, the present disclosure provides a new technical solution, which is applicable to solve technical problems that cause data service interruption due to single data source.

In order to achieve the above purpose, the present disclosure provides the following technical solutions:

According to a first aspect of the present disclosure, the present disclosure provides a method for processing data service, which may include the following operations including:

acquiring a data service request initiated by a first user to a second user, the data service request carrying a service limit of the data service;

acquiring a data source list adopted by the second user in accordance with the data service request; and

transferring an amount of funds for the service limit to a first account corresponding to the first user in accordance with the data source list.

According to a second aspect of the present disclosure, the present disclosure provides an apparatus for processing data service, which may include the following modules:

a first acquisition module that acquires a data service request initiated by a first user to a second user, the data service request carrying a service limit of the data service;

a second acquisition module that acquires a data source list adopted by the second user in accordance with the data service request acquired by the first acquisition module; and

a transfer module that transfers an amount of funds for the service limit to a first account corresponding to the first user in accordance with the data source list acquired by the second acquisition module.

As shown from the above technical solutions, the present disclosure transfers an amount of funds within a limit to the first account corresponding to the first user in accordance with the data source list, which avoids an interruption of data service caused by an insufficient single data source, and thus facilitates the data service, and enhances a quality of service of the data service.

### BRIEF DESCRIPTION OF THE DRAWINGS

FIG. 1 shows a schematic flow chart of an example method for processing data service according to an example embodiment of the present disclosure.

FIG. 2A shows a schematic flow chart of an example method for processing data service according to another example embodiment of the present disclosure.

FIG. 2B shows a schematic view of an example data source list according to another example embodiment of the present disclosure.

FIG. 3 shows a structural schematic view of an example server according to an example embodiment of the present disclosure.

FIG. 4 shows a structural schematic view of an example apparatus for processing data service according to an example embodiment of the present disclosure.

FIG. 5 shows a structural schematic view of an example apparatus for processing a data service according to another example embodiment of the present disclosure.

### DETAILED DESCRIPTION

The example embodiments are described herein in great detail, and the examples are presented in the accompanying drawings. When the following description involves the accompanying drawings, unless otherwise indicated, the same numbers in different drawings represent the same or similar elements. The implementations described in the following example embodiments do not represent all of the implementations that are consistent with the present disclosure. Instead, they are merely examples of apparatuses and methods that are consistent with some aspects of the present disclosure as claimed in the claims.

The terminology used in the present disclosure is for the purpose of describing particular embodiments only and is not intended to limit the present disclosure. As used in the present disclosure and appended claims, the singular forms “a”, “an” and “the” are intended to include the plural forms as well, unless the context clearly indicates otherwise. It will be further understood that the term “and/or” used herein specifies and includes any or all the possible combinations of one or more associated items that are stated.

It shall be understood that although the present disclosure may use terms such as, first, second, third and so on, to describe various kinds of information, such information will not be limited thereto. Those terms are merely used for distinguishing information of the same type. For example, without departing from the scope of the present disclosure, the first information may also be referred to as the second information, and similarly, the second information may be called the first information as well. Depending upon the specific language context, “If” used herein may be interpreted as “when”, “in the case that”, or “in response to determining that.”

The present disclosure acquires a data service request initiated by a first user to a second user, acquires a data source list adopted by the second user in accordance with the data service request, and transfers an amount of funds for the service limit to a second account corresponding to the first user in accordance with the data source list, which guarantees the diversification of data sources and avoids an interruption of the data service caused by a single data source. In order to further describe the present disclosure, the following example embodiments are provided.

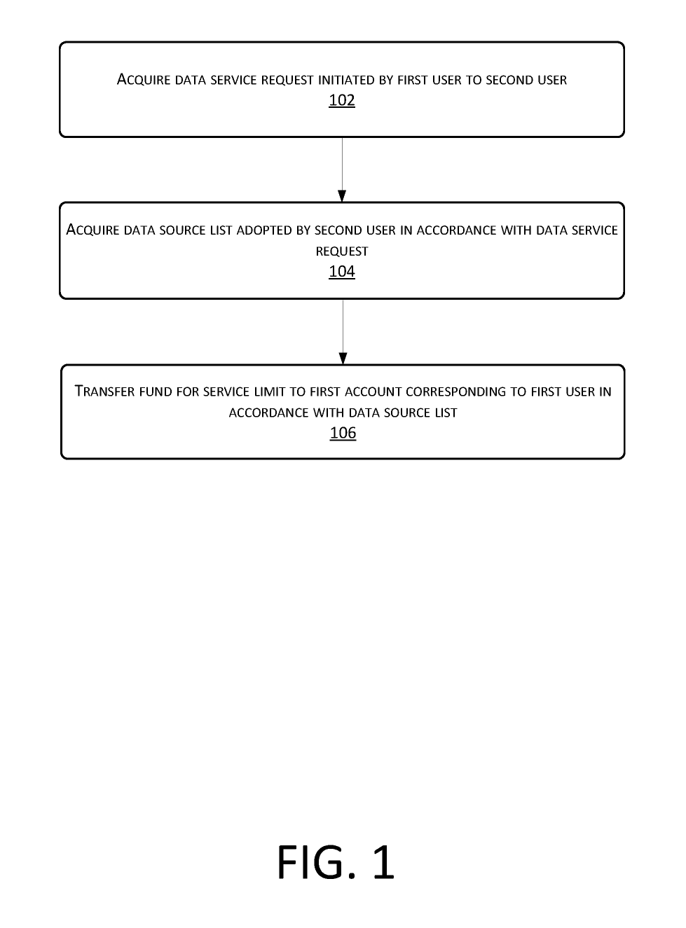

Referring to FIG. 1, FIG. 1 shows an example method for processing data service according to an example embodiment of the present disclosure, which may be applied to a server, and may include the following operations.

At 102, a data service request initiated by a first user to a second user is acquired. The data service request carries a service limit of the data service.

For example, the first user may be a buyer at an electronic commerce (E-commerce) platform, and the second user may be a seller at the E-commerce platform. In this case, the data service request may be a refund request initiated by the buyer to the seller when the buyer returns the goods after the online shopping. The first user may also be a logistics company, and the second user may be a seller at the E-commerce platform. In this case, the data service request may be a request of deducting logistics freight initiated by the logistics company to the seller. The first user may also be a seller, and the second user may be a buyer. When the buyer periodically makes payments to the seller or makes repayments to the seller, the data service request may be a request for the first user to request the buyer to pay a sum of money for a corresponding limit. The data service request may carry a service label, and by using the service label, data services, such as the buyer requesting a refund from the seller, the logistics company requesting the seller to deduct the logistics freight, or the seller requesting the buyer to make payments periodically, are identified.

At 104, a data source list adopted by the second user is acquired in accordance with the data service request.

In this example embodiment, the data source list may include: an account balance stored by the second user at the E-commerce platform (the account balance belongs to an amount of funds in a user account that is freely used by the user); a deposit provided by the second user to the E-commerce platform, which is stored in an account of the second user, but is frozen by the E-commerce platform, and is only used in specific services, instead of being withdrawn freely; and a third-party funding from a third party (for example, a bank system) (stored in an account provided by the third party, and requires the second user to sign a relevant agreement with the third party), in which the amount of funds paid by the third party is acquired through the E-commerce platform, and such third-party funding requires the second user to pay the usage cost, and users who have an agreement with the third party may be funded. Therefore, the data source list adopted by the second user may be determined in accordance with the actual situation of the second user, which may include one or more of the above examples or any combination thereof In this example embodiment, the user may either be a buyer or a seller, which may be determined in accordance with a specific context. Specifically, the amount of funds in the data source list, such as the balance, deposit, third-party funding, etc., may be fund data of a corresponding account stored in a server, which may be stored in a form of account fund. Certainly, the amount of funds data may also be stored in an independent database, or stored in different databases, which is not specifically limited in the example embodiments of the present disclosure.

At 106, an amount of funds for the service limit is transferred to a first account corresponding to the first user in accordance with the data source list.

In this example embodiment, since different users have different balances, different deposits, and have signed different agreements with the third party, in the data source lists of different users, each data source is also different, and each data source in the data source list has a different limit. Therefore, by coordinating each data source to the greatest extent by using the data source list, the requirements of various data service requests are satisfied.

As shown from the above example embodiments, the present disclosure transfers a service limit to the first account corresponding to the first user in accordance with the data source list, which avoids an interruption of the data service caused by a single data source, and further facilitates the data service, and enhances a quality of service of the data service.

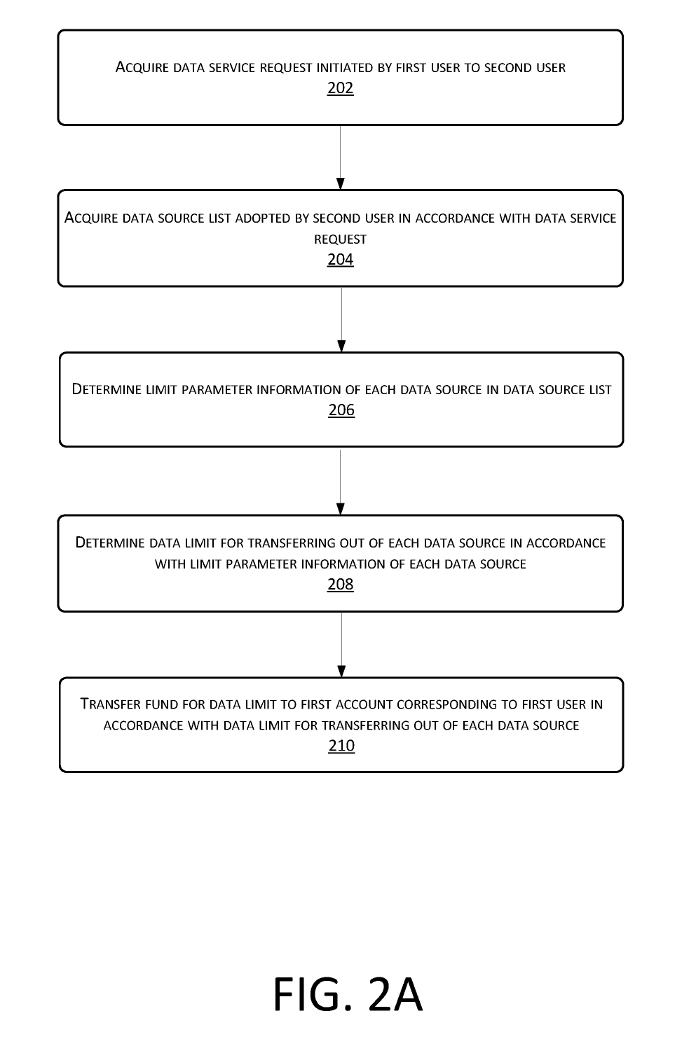

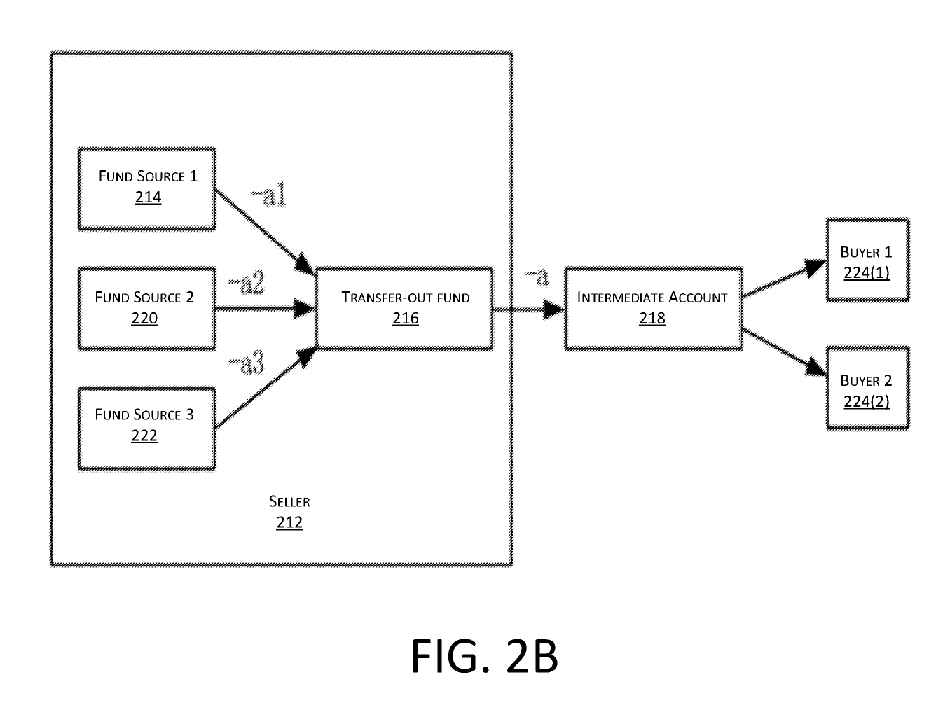

Referring to FIG. 2A, which is a schematic flow chart of another example method for processing data service according to another example embodiment of the present disclosure. Illustratively, in case of the first user requesting the second user to refund, the method includes the following operations.

At 202, a data service request initiated by a first user to a second user is acquired. The data service request carries a refund limit for the second user.

For the detailed descriptions of 202, reference may be made to relevant descriptions of 102, which will not be further described.

At 204, a data source list adopted by the second user is acquired in accordance with the data service request.

In this example embodiment, if the second user is a seller based on the E-commerce platform, the data source list of the seller may include the seller's account balance at the E-commerce platform, a deposit provided to the E-commerce platform, and an amount of funds based on an agreement between the seller and the third party (for example, a bank or an E-commerce platform). In another embodiment, the seller may not sign any funding agreement with a third party. In this case, the data source list may include the seller's account balance in the E-commerce platform and a deposit provided to the E-commerce platform.

At 206, limit parameter information of each data source in the data source list is determined.

In this example embodiment, the limit parameter information at least includes: a current limit, a maximum transfer-out limit, a reserved limit of each data source, and so on. For example, as shown in FIG. 2B, it is determined that the seller's data source list includes Funds Source 1 214, Fund Source 2 220, and Fund Source 3 222. For example, the amount of funds Source 1, the amount of funds Source 2, and the amount of funds Source 3 are the seller's account balance, the deposit provided to the E-commerce platform, and the amount of funds based on an agreement between the seller and the third party (for example, a bank or an E-commerce platform) respectively. For instance, the current limit for the account balance is 400 RMB. The deposit provided to the E-commerce platform is 1000 RMB, and the reserved limit for the deposit is 500 RMB. The maximum limit for the amount of funds based on an agreement signed with the third party is 1000 RMB, and the current limit for the third-party is 2000 RMB.

At 208, a data limit for transferring out of each data source is determined in accordance with the limit parameter information of each data source.

In the data source list, the seller's account balance may not have an upper limit. However, although the deposit belongs to the user, it is frozen, so that only specified data services may use the deposit. Moreover, the usage of the deposit is required to comply with an agreement between the seller and the E-commerce platform provider. As the amount of funds from the third party belongs to the third party, it needs to be based on an agreement between the third party and the seller, and may only be used in the specified data services. For example, it is stipulated in an agreement between the seller and the E-commerce platform provider that a deposit of at least 1000 RMB should be prepaid, in which no more than 500 RMB may be freely used by the seller (that is, the reserved limit for the deposit is 500 RMB). In terms of the amount of funds, it is agreed between the seller and the third party that the maximum limit for the third-party funding is 500 RMB. For example, the refund limit is 2000 RMB, and the current limit for the account balance as determined at 206 is 400 RMB, the disposable limit for the deposit is 500 RMB, and the limit for the third-party funding is 1000 RMB. Thus, the limit for the buyer is 400+500+1000=1900 RMB. In this case, if it is determined at 202 that the refund limit requested by the buyer to the seller is 300 RMB, 300 RMB is transferred out of the seller's account balance directly. If the refund limit is 500 RMB, 400 RMB is deducted from the seller's account balance firstly, and then 100 RMB is deducted from the seller's deposit. If the refund limit is 1000 RMB, 400 RMB is deducted from the seller's account balance firstly, and then 500 RMB is deducted from the seller's deposit, and finally 100 RMB is transferred out of the third-party, thereby reaching the refund limit of 1000 RMB. The deduction sequence in this example embodiment may also be carried out in a set order, for example, firstly on the third-party funding, then the deposit, and finally the user's account balance.

At 210, an amount of funds for the data limit is transferred to the first account corresponding to the first user in accordance with the data limit for transferring out of each data source.

In an example embodiment, a data limit transferred out of each data source may be transferred into an intermediate account, and an amount of funds for the data limit may be transferred to the first account corresponding to the first user through the intermediate account, which guarantees that the amount of funds being transferred out will not be used by the second user for other purposes, that is, specific fund for specific purpose. Furthermore, the intermediate account may be an account set on the E-commerce platform. For example, through operations at 208, if it is determined by using the data source list that a sufficient refund limit is provided to the buyer, a refund limit of 1000 RMB is transferred to the buyer's account. As shown in FIG. 2B, the first user may be a plurality of buyers (for example, Buyer 1, and Buyer 2). When a plurality of buyers raises refund requests to the same seller, the refund limit for each buyer is determined by adopting the same method as described above.

In this example embodiment, for the purpose of illustration, the data source list is used to illustrate the seller's fund source. Since the seller's fund sources depend on different agreements signed between the seller and the E-commerce platform provider and the third party, the seller's fund sources may have different limits. Thus, by coordinating each data source to the greatest extent by using the amount of funds source list, the buyers' refund services are guaranteed, and the quality of service for the buyers during the refund is enhanced.

Based on the above example embodiment, the method may further include the following operations.

If the transfer-out limit determined in accordance with the data source list is less than the service limit, a prompt message of data service failure is sent to the first user.

For example, the buyer requests the seller to pay a refund of 2000 RMB. However, the seller's current account balance is 200 RMB, the disposable limit for the deposit is 500 RMB, and the current account of the third party is 1000 RMB. In this case, the transfer-out limit is 200+500+1000=1700 RMB, which is less than the refund limit of 2000 RMB. It is necessary to return a prompt message of data service failure to the buyer. Such a prompt message informs the buyer to wait until that the seller is capable of paying the refund limit to the buyer, the data service request will be initiated once again.

Further referring to FIG. 2B, in a scenario when the buyer requests the seller 212 to pay a refund, the “service limit” that is requested by the buyer to be transferred out of the seller is an expense amount a. In case that the expense amount a comes from the seller's balance account by default, if the seller's balance account is sufficient, the buyer's operation of requesting the seller to make a refund is implemented successfully; and if the seller's balance account is not sufficient, it is necessary to try other fund sources. For example, after the amount of funds is transferred out from the Fund Source 1 214 to the “Transfer-out fund” 216, such amount of funds may be transferred to an intermediate account 218 to guarantee that the amount of funds will not be used by the seller 212 for other purposes, that is, specific fund for specific purpose. At this point, the data source list is acquired. Alternatively, the “Fund Source 1” 214 may also be frozen at the “Transfer-out fund” 216. Correspondingly, the amount of funds from the Fund Source 1 214, Fund Source 2 220, and Fund Source 3 222 are restricted by corresponding limit parameter information, and the limit parameter information includes, for example, a minimum amount, a maximum amount, a quota, a specific currency, and so on. In addition, even if the amount of funds from the fund sources is sufficient, the operation of transferring out fund may still be determined in accordance with the buyers' actual requirements. If any fund source in the fund source list cannot meet the requirement, another fund sources may be triggered. If the total limit of all fund sources still cannot satisfy the service limit, the service request will fail correspondingly. There might be multiple buyers such as buyer 1 224(1) and buyer 2 224(2) as shown in FIG. 2B.

For specific implementations of the scenarios where the logistics company requests the seller to pay the logistics freight and the seller requests the buyer to make a payment periodically, reference may be made to the above scenario where the buyer requests the seller to make a refund, which will not be further described herein.

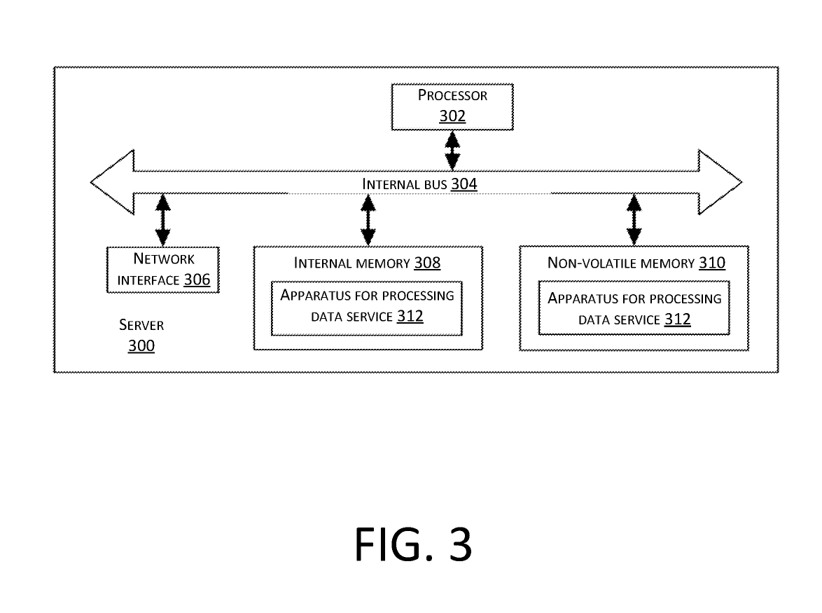

Corresponding to the method for processing data service, the present disclosure further provides a structural schematic view of an example server according to an example embodiment of the present disclosure, as shown in FIG. 3. Referring to FIG. 3, in terms of hardware, a server 300 may include a processor 302, an internal bus 304, a network interface 306, an internal memory 308, and a nonvolatile memory (NVM) 310.

The internal memory 308 and the NVM 310 are examples of memory or computer-readable media. As defined herein, the computer-readable media does not include transitory media such as a modulated data signal and a carrier wave.

The server 300 may also include hardware needed by other services, such as an input and output interface (now shown in FIG. 3). The processor 302 may read corresponding computer-executable instructions or computer program from the NVM 310 to the internal memory 308, and then run the computer-executable instructions or computer program, thereby forming an apparatus for processing data service 312 at a logic level. Certainly, in addition to the software implementations, the present disclosure may also include other forms of implementations, for example, logic device or a combination of software and hardware, and so on. That is, the entities performing the processing operations are not limited to the logical unit, and may be hardware or logic device.

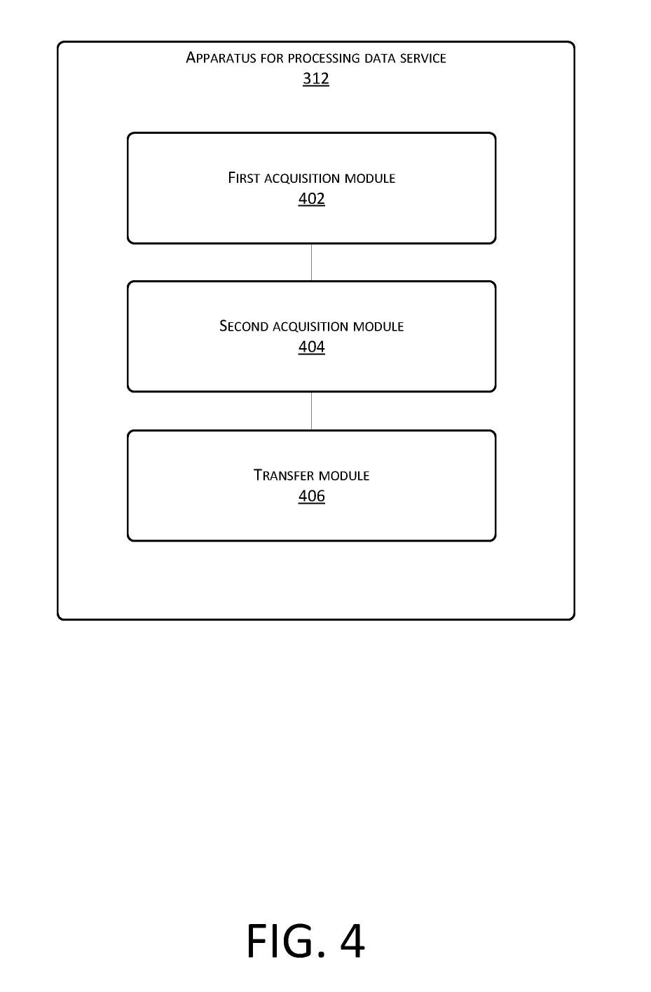

Referring to FIG. 4, in terms of software implementation, an example apparatus 312 for processing data service may include: a first acquisition module 402, a second acquisition module 404, and a transfer module 406.

The first acquisition module 402 acquires a data service request initiated by a first user to a second user, the data service request carrying a service limit of the data service. The second acquisition module 404 acquires a data source list adopted by the second user in accordance with the data service request acquired by the first acquisition module 402. The transfer module 406 transfers an amount of funds for the service limit to a first account corresponding to the first user in accordance with the data source list acquired by the second acquisition module 404.

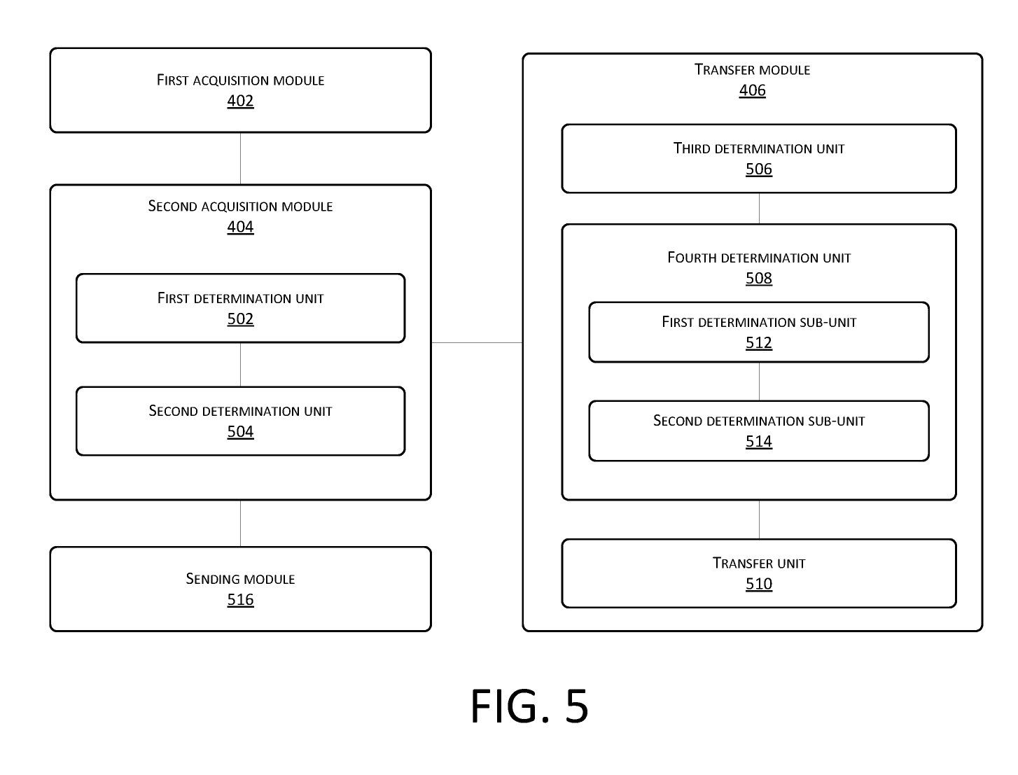

Referring to FIG. 5, for example, the second acquisition module 404 may include the following units:

a first determination unit 502 that determines a type of the data service in accordance with the data service request; and

a second determination unit 504 that determines the data source list adopted by the second user in accordance with the type of the data service.

For example, the transfer module 406 may include the following units:

a third determination unit 506 that determines limit parameter information of each data source in the data source list;

a fourth determination unit 508 that determines a data limit transferred out of each data source in accordance with the limit parameter information of each data source determined by the third determination unit 506; and

a transfer unit 510 that transfers an amount of funds for the data limit to the first account corresponding to the first user in accordance with the data limit transferred out of each data source determined by the fourth determination unit 508. Furthermore, the transfer unit 510 may include: a transfer-in sub-unit (not shown in FIG. 5) that transfers the data limit transferred out of each data source into an intermediate account; and a transfer-out sub-unit (not shown in FIG. 5) that transfers the amount of funds for the data limit to the first account corresponding to the first user via the intermediate account.

Optionally, the limit parameter information may include: a current limit, a maximum transfer-out limit, and a reserved limit of each data source.

The fourth determination unit 508 may include the following sub-units:

a first determination sub-unit 512 that determines a size relationship between the current limit in each data source of the data source list and the corresponding maximum transfer-out limit; and

a second determination sub-unit 514 that determines to transfer out a limit corresponding to a difference between the current limit and the reserved limit to the first account, if the first determination sub-unit 512 determines that the current limit is less than the maximum transfer-out limit.

Furthermore, the apparatus 312 may further include a sending module 516 that sends a prompt message of data service failure to the first user, if the transfer-out limit determined in accordance with the data source list acquired by the second acquisition module 404 is less than the service limit acquired by the first acquisition module 402.

Thus, in the present disclosure, the transfer module 406 transfers the service limit to the first account corresponding to the first user in accordance with the data source list acquired by the second acquisition module 404, which avoids an interruption of data service caused by an insufficient single data source, and thus facilitates the data service and enhances a service quality of the data service.

It should also be noted that, the term “comprise,” “include” and variants thereof are intended to cover non-exclusive inclusion, so that an expression of “including a process, a method, an article or a device of a series of elements” not only includes these elements, but also includes other elements not explicitly listed, or further includes inherent elements of the process, the method, the article or the device. Without further limitation, an element as defined by a statement “ including a . . . ” is not exclusive of additional identical elements in the process, the method, the article or the device of the element.

The above descriptions are merely example embodiments of the present disclosure, and are not intended to limit the present disclosure. Any modification, equivalent replacement, improvement or the like made with the spirit and principle of the present disclosure should be included in the scope of the present disclosure.

What is claimed is:

1. A method comprising:
acquiring a data service request initiated by a first user to a second user, the data service request carrying a service limit of a data service;
acquiring a data source list adopted by the second user in accordance with the data service request; and
transferring an amount of funds for the service limit to a first account corresponding to the first user in accordance with the data source list.

2. The method of claim 1, wherein acquiring the data source list adopted by the second user in accordance with the data service request includes:
determining a type of the data service in accordance with the data service request; and
determining the data source list adopted by the second user in accordance with the type of the data service.

3. The method of claim 1, wherein transferring the amount of funds for the service limit to the first account corresponding to the first user in accordance with the data source list includes:
determining limit parameter information of a respective data source in the data source list;
determining a data limit transferred out of the respective data source in accordance with the limit parameter information of the respective data source; and
transferring the amount of funds for the data limit to the first account corresponding to the first user in accordance with the data limit transferred out of the respective data source.

4. The method of claim 3, wherein the limit parameter information includes:
a current limit of the respective data source;
a maximum transfer-out limit of the respective data source; and
a reserved limit of the respective data source.

5. The method of claim 4, wherein the determining the data limit transferred out of the respective data source in accordance with the limit parameter information of the respective data source includes:
determining a size relation between the current limit of the respective data source and the maximum transfer-out limit of the respective data source; and
in response to determining that the current limit is less than the maximum transfer-out limit, transferring a limit corresponding to a difference between the current limit and the reserved limit to the first account.

6. The method of claim 4, wherein the transferring the amount of funds for the data limit to the first account corresponding to the first user in accordance with the data limit transferred out of the respective data source includes:
transferring a respective data limit transferred out of the respective data source into an intermediate account; and
transferring the amount of funds for the data limit to the first account corresponding to the first user via the intermediate account.

7. The method of claim 1, further comprising sending a prompt message of data service failure to the first user in response to determining that a transfer-out limit determined in accordance with the data source list is less than the service limit.

8. A server comprising:
a first acquisition module that acquires a data service request initiated by a first user to a second user, the data service request carrying a service limit of a data service;
a second acquisition module that acquires a data source list adopted by the second user in accordance with the data service request; and
a transfer module that transfers an amount of funds for the service limit to a first account corresponding to the first user in accordance with the data source list.

9. The server of claim 8, wherein the second acquisition module includes:
a first determination unit that determines a type of the data service in accordance with the data service request; and
a second determination unit that determining the data source list adopted by the second user in accordance with the type of the data service.

10. The server of claim 8, wherein the transfer module includes:
a third determination unit that determines limit parameter information of a respective data source in the data source list;
a fourth determination unit that determines a data limit transferred out of the respective data source in accordance with the limit parameter information of the respective data source; and
a transfer unit that transfers the amount of funds for the data limit to the first account corresponding to the first user in accordance with the data limit transferred out of the respective data source.

11. The server of claim 10, wherein the limit parameter information includes:
a current limit of the respective data source;
a maximum transfer-out limit of the respective data source; and
a reserved limit of the respective data source.

12. The server of claim 11, wherein the fourth determination unit includes:
a first determination sub-unit that determines a size relation between the current limit of the respective data source and the maximum transfer-out limit of the respective data source; and
a second determination sub-unit that, in response to determining that the current limit is less than the maximum transfer-out limit, transfers a limit corresponding to a difference between the current limit and the reserved limit to the first account.

13. The server of claim 11, wherein the transfer unit includes:
a transfer-in sub-unit that transfers a respective data limit transferred out of the respective data source into an intermediate account; and
a transfer-out sub-unit that transfers the amount of funds for the data limit to the first account corresponding to the first user via the intermediate account.

14. The server of claim 8, further comprising a sending module that sends a prompt message of data service failure to the first user in response to determining that a transfer-out limit determined in accordance with the data source list is less than the service limit.

15. One or more memories having stored thereon computer-executable instructions that are executable by one or more processors to perform operations comprising:
acquiring a data service request initiated by a first user to a second user, the data service request carrying a service limit of a data service;
acquiring a data source list adopted by the second user in accordance with the data service request; and
transferring an amount of funds for the service limit to a first account corresponding to the first user in accordance with the data source list.

16. The one or more memories of claim 15, wherein acquiring the data source list adopted by the second user in accordance with the data service request includes:
determining a type of the data service in accordance with the data service request; and
determining the data source list adopted by the second user in accordance with the type of the data service.

17. The one or more memories of claim 16, wherein transferring the amount of funds for the service limit to the first account corresponding to the first user in accordance with the data source list includes:
determining limit parameter information of a respective data source in the data source list;
determining a data limit transferred out of the respective data source in accordance with the limit parameter information of the respective data source; and
transferring the amount of funds for the data limit to the first account corresponding to the first user in accordance with the data limit transferred out of the respective data source.

18. The one or more memories of claim 17, wherein the limit parameter information includes:
a current limit of the respective data source;
a maximum transfer-out limit of the respective data source; and
a reserved limit of the respective data source.

19. The one or more memories of claim 18, wherein the determining the data limit transferred out of the respective data source in accordance with the limit parameter information of the respective data source includes:
determining a size relation between the current limit of the respective data source and the maximum transfer-out limit of the respective data source; and
in response to determining that the current limit is less than the maximum transfer-out limit, transferring a limit corresponding to a difference between the current limit and the reserved limit to the first account.

20. The one or more memories of claim 18, wherein the transferring the amount of funds for the data limit to the first account corresponding to the first user in accordance with the data limit transferred out of the respective data source includes:
transferring a respective data limit transferred out of the respective data source into an intermediate account; and
transferring the amount of funds for the data limit to the first account corresponding to the first user via the intermediate account.
